(19) United States
(12) Patent Application Publication
(10) Pub. No.: US 2017/0284475 A1
(43) Pub. Date: Oct. 5, 2017

(54) Torsional Vibration Damper And Start-Up Element

(71) Applicant: ZF FRIEDRICHSHAFEN AG, Friedrichshafen (DE)

(72) Inventors: Martin HERTEL, Bergrheinfeld (DE); Michael WINTERSTEIN, Gochsheim (DE); Joerg SUDAU, Niederwerrn (DE); Armin STÜRMER, Rannungen (DE); Christian WEBER, Ebersburg (DE); Christoph SASSE, Schweinfurt (DE); Thomas KRÜGER, Üchtelhausen (DE); Erwin WACK, Niederwerrn (DE)

(21) Appl. No.: 15/512,199

(22) PCT Filed: Aug. 13, 2015
(86) PCT No.: PCT/EP2015/068614

§ 371 Date: Mar. 17, 2017

(30) Foreign Application Priority Data
Sep. 19, 2014 (DE) 10 2014 218 926.8

(51) Int. Cl. F16D 3/12; F16F 15/123

(52) U.S. Cl. CPC F16D 3/12; F16F 15/1234; F16F 15/12366; F16F 2222/08; F16F 2232/02; F16H 45/02

(57) ABSTRACT

A torsional vibration damper has an input, an output and an intermediate mass arranged therebetween, a first plurality of spring elements coupled between the input and the intermediate mass that form a first stage, a second plurality of spring elements coupled between the intermediate mass and the output that form a second stage of the torsional vibration damper, at least one damper mass to damp the vibration component of the rotational movement. The first stage of the torsional vibration damper has a progressive first characteristic with at least one transition point. The second stage of the torsional vibration damper has a progressive, second characteristic with at least one transition point. All of the transition points of the first characteristic and the second characteristic are spaced apart from one another with respect to torque.

### CROSS REFERENCE TO RELATED APPLICATIONS

This is a U.S. national stage of application No. PCT/EP2015/068614, filed on Aug. 13, 2015. Priority is claimed on German Application No. DE102014218926.8, filed Sep. 19, 2014, the content of which is incorporated here by reference.

### BACKGROUND OF THE INVENTION

### 1. Field of the Invention

Embodiment examples are directed to a torsional vibration damper and a start-up element such as can be used within the framework of a powertrain of a motor vehicle and to a corresponding powertrain for a motor vehicle.

### 2. Description of the Prior Art

In many areas of mechanical engineering, plant engineering and vehicle engineering, rotational movements are used to transmit mechanical energy. In this regard, it can happen for various reasons that one or more torsional vibrations are superimposed on a rotational movement of this kind. Torsional vibrations can be caused through the engine that is used to generate the rotational movement, but they can also be caused by discontinuous loads or abrupt withdrawals of power. Such torsional vibrations, also referred to as rotational irregularities, can stress components such as transmissions and differentials, for example. They may also be perceived as annoying when they produce noise or vibrations, for example.

Torsional vibration dampers are used to reduce or even completely eliminate torsional vibrations of this kind. An example is a powertrain of a motor vehicle in which the rotational movement is generated by a reciprocating piston engine, i.e., for example, a diesel engine or Otto engine. By reason of its construction and design, the latter often produces an abrupt development of force and torque that can lead to the above-described torsional vibrations even as the rotational movement is generated. Torsional vibration dampers can be utilized, for example, to at least reduce the intensity of these torsional vibrations.

Owing to tightening ecological and economic constraints, efforts are being made to reduce carbon dioxide (CO₂) emissions and to save costs at the same time. On the part of engine manufacturers, this is attempted, for example, by decreasing the cubic capacity and reducing the speed of engines. However, this concept, also known as downsizing and downspeeding, can result in a further exacerbation of the problem brought about by rotational irregularities and torsional vibrations. Thus the torsional vibrations are not only perceived as unpleasant and accordingly contribute to loss of comfort but, beyond this, they can also result in a shortening of service life, for example, because of occurring vibrations. Therefore, there is a need to find a better compromise between the performance of a torsional vibration damper of this kind for damping torsional vibrations, the manufacture and implementation thereof, the required installation space and reliability of the torsional vibration damper and of the system comprising it.

DE 10 2012 221 544 A1 relates to a powertrain with an internal combustion engine having a predetermined quantity of cylinders in which all of the cylinders are operated in a first operating condition, while a portion of the cylinders is switched off in a second operating condition. The torsional vibration damper system described in this document contains at least one centrifugal pendulum absorber.

DE 10 2011 084 744 A1 relates to a drive system for a vehicle which likewise comprises an internal combustion engine and a torsional vibration damper arrangement. Also, DE 10 2008 040 164 A1 relates to a hydrodynamic clutch device, particularly a torque converter, while DE 10 2011 017 381 A1 is directed to a dual mass flywheel in a powertrain of a motor vehicle. US 2014/0087889 A1 relates to a torque transmission unit for a motor vehicle in the form of a torque converter. DE 10 2005 058 783 A1 relates to a torsion damper with a multi-step characteristic for a torque converter. The multiple steps are realized through a combination of two-step spring characteristics and various stop torques.

Although the example above is taken from vehicle engineering, more precisely automotive engineering, similar examples and sets of problems also occur in other areas of mechanical engineering, plant engineering and vehicle engineering. Accordingly, torsional vibration dampers are also used in these areas.

### SUMMARY OF THE INVENTION

There is a need to find a better compromise with respect to the damping of torsional vibrations, the implementation and production of torsional vibration dampers, the installation space needed by the latter, and their reliability.

This need is met by a torsional vibration damper and a starting element as disclosed.

A torsional vibration damper for damping a vibration component of a rotational movement such as can be used, for example, in a powertrain of a motor vehicle, and comprises an input, an output and an intermediate mass arranged between the input and the output. It further comprises a first plurality of spring elements coupled between the input and the intermediate mass that form a first stage of the torsional vibration damper and a second plurality of spring elements coupled between the intermediate mass and the output that form a second stage of the torsional vibration damper. It further comprises at least one damper mass configured to perform an oscillation depending on the rotational movement to damp the vibration component of the rotational movement. The first stage of the torsional vibration damper has a progressive first characteristic with at least one transition point. The second stage of the torsional vibration damper also has a progressive, second characteristic with at least one transition point. All of the transition points of the first characteristic of the first stage of the torsional vibration damper and of the second characteristic of the second stage of the torsional vibration damper are spaced apart from one another with respect to torque.

As will be explained in more detail in the following, an improved damping of torsional vibrations is made possible through the combination of the first stage and second stage of the torsional vibration damper with a tuned mass vibration damper having at least one damper mass, both the first stage and second stage of the torsional vibration damper having progressive characteristics in each instance, without having a significantly negative effect on aspects relating to the implementation and production of the torsional vibration damper or its installation space. Owing to the fact that the transition points of the progressive first and second characteristics of the two respective stages are spaced apart from one another, it is possible not only to achieve an improved damping of torsional vibrations but, over and above this, also to reduce an abrupt change in the characteristic and therefore in the damping behavior and response behavior of the torsional vibration damper. Accordingly, it may be possible to prevent abrupt changes and thus, if necessary, to inhibit abrupt back-coupling from the torsional vibration damper into other components. Accordingly, as will be explained more fully in the following, the corresponding distance between the transition points can also be of benefit to a simpler technical implementation. By using a torsional vibration damper of this type, the compromise described above with respect to damping torsional vibrations, implementation and production of the torsional vibration damper, the installation space required by the latter and its reliability, which is reflected not least of all also by the response behavior of the torsional vibration damper and, therefore, the back-coupling to other components, can accordingly be improved. Accordingly, it can be possible to realize an efficient solution with respect to installation space which may even make do without additional installation space.

The first stage and second stage of the torsional vibration damper are connected in series with one another via the intermediate mass. The characteristics of the first stage and second stage of the torsional vibration damper are substantially determined jointly by the respective plurality of spring elements, also referred to as first spring set and second spring set. The spring elements of the respective plurality of spring elements can be arranged, for example, on the same radii or comparable radii with respect to an axis or axial direction around which the rotational movement is executed. Accordingly, the input, the output and the intermediate mass can be rotatable around the common axis.

The characteristics represent the torque M provided by the first stage and second stage of the torsional vibration damper during a static twist around a defined twist angle φ. The twist angle can be oriented, for example, to an unloaded state of equilibrium or basic state in which a vanishing torque (0 Nm; Nm=Newtonmeter [SI unit of torque]) is generated or provided by the respective stage of the torsional vibration damper. In the first stage, the twist angle can relate to the twist angle between the input and the intermediate mass and, in the second stage, to the twist angle between the intermediate mass and the output of the torsional vibration damper.

A progressive characteristic has a monotonically increasing curve in a mathematical sense. More precisely, even the change in torque as function of the twist angle has at least a monotonically increasing, possibly even a sharply monotonically increasing, curve. A monotonically increasing curve always has a slope that is always greater than or equal to 0 (zero). Correspondingly, a sharply monotonically increasing curve has a slope that is always greater than 0 (zero).

In other words, a progressive characteristic at a first twist angle φ1 has a smaller slope or change in torque as function of the twist angle C1=dM/dφ(φ1) than at a second twist angle φ2 at which the slope or change in torque C2=dM/dφ (φ2). The second twist angle φ2 is greater than the first twist angle φ1. The characteristic can accordingly have a constant and/or increasing slope for all twist angles with an increasing twist angle, for example. Thus the characteristic can always be progressive above a maximum rotational angle range. The change in torque as function of twist angle C is also referred to as stiffness of the respective stage of the torsional vibration damper.

The transition point occurs at a twist angle φ3 which lies between the first twist angle φ1 and the second twist angle φ2 so that φ1<φ3<φ2. Accordingly, the transition point has the third twist angle φ3. At the transition point, the respective characteristic has a change in torque as function of the twist angle C3 =dM/dφ(φ3) which lies between changes C1 and C2 at the first twist angle φ1 and at the second twist angle φ2, respectively, in case of a continuously progressive characteristic. However, if the progressive characteristic has a knee, an abrupt change in the slope of the characteristic occurs at the transition point and, accordingly, at the third twist angle φ3. Accordingly, the change in torque as function of the twist angle is discontinuous at this point in a mathematical sense. Accordingly, the transition points of the first characteristic and of the second characteristic are spaced apart from one another with respect to torque and also with respect to the transition points of the other respective characteristic.

Based on the configuration of the objects, components and systems described herein that rotates at least partially during operation, the present description often assumes a cylindrical coordinate system whose cylinder axis typically corresponds to the axial direction of the rotational movement and, therefore, to the axial direction of the respective objects, components and systems and possibly even coincides with them. Accordingly, within the framework of the cylindrical coordinate system any location or any direction or line can be described by an axial component, a radial component and a component in circumferential direction. While the radial direction and the circumferential direction, for example, may depend on one another in a Cartesian coordinate system, the same radial direction is always assumed herein regardless of the respective angle along the circumferential direction. This also applies in a corresponding manner for the circumferential direction. Thus while in a corresponding cylindrical coordinate system the unit vectors for the circumferential direction and the radial direction in the Cartesian coordinate system are not constant, “radial direction” within the meaning of the present description always denotes that direction following the corresponding radial unit vector. This also applies correspondingly to the circumferential direction.

In a torsional vibration damper, the transition points of the first characteristic and of the second characteristic with respect to torque can optionally have a distance from one another of at least 20 Nm. Accordingly, it may be possible to prevent excessive back-coupling of torsional vibration into the system through the abruptly changing characteristic.

Additionally or alternatively in a torsional vibration damper, adjacent transition points of the first characteristic and of the second characteristic with respect to torque can in turn have a spacing of at most 100 Nm with respect to torque. In this way, it can be possible to find a better compromise with respect to a gentle rise in the characteristic on the one hand and utilization of the available maximum twist angle on the other hand. In this connection, transition points may be regarded as adjacent, regardless of the characteristics associated with them, when there are no other transition points between them. Since the transition points are spaced apart from one another, they typically do not adjoin one another when regarded as a determined twist angle.

Additionally or alternatively in a torsional vibration damper, the first characteristic and/or the second characteristic have at least one portion which is progressive in multiple steps and which comprises the at least one transition point. Accordingly, it can be possible to realize a corresponding progressive characteristic with comparatively simple constructional means. In this respect, at least one portion, but also the entire characteristic, can be configured progressively in multiple steps. In other words, the corresponding characteristic can be exclusively multi-stepped, for example. The portion which is progressive in multiple steps has a first sub-portion with a substantially constant first slope and a second sub-portion immediately adjoining the transition point to the first sub-portion with a substantially constant second slope for larger twist angles than those of the first sub-region, where the first slope is greater than the second slope. The configuration as multi-step characteristic includes the possibility of implementing two, but also more than two, sub-portions with corresponding slopes which increase toward larger twist angles. The stiffnesses of the second sub-portion can be greater than the stiffness of the first sub-portion, for example, by a factor between a minimum value and a maximum value. Depending on the specific implementation and requirement profile, the minimum value of the factor can be 1.6 or 2, for example. The smaller the value, the gentler the corresponding rise at the transition point. Depending on implementation and tolerance class, choosing a value that is too small may possibly be disadvantageous to the overall layout of the torsional vibration damper. Accordingly, minimum values with respect to the factor of 1.6 and 2 can possibly influence the above-mentioned compromise in a positive manner not least of all with respect to production and implementation. On the other hand, it may be advisable to select the factor so as not to be higher than a maximum factor amounting to 7 or at most 5.5, for example. If the selected factor is too large, abrupt back-coupling into components of the system, including inter alia the torsional vibration damper, can occur. Accordingly, a corresponding configuration can make it possible to improve the reliability of the torsional vibration damper and of the system in which it is implemented.

In a torsional vibration damper of this type, the first characteristic and/or the second characteristic can optionally have at least one portion with a characteristic that is progressive in at least three steps. Accordingly, it can be possible to allow the progressive configuration of the characteristic to rise more gently by comparatively simple construction and accordingly to realize a gentle damping for small twist angles, while an overload during especially large torques and certain twist angles can be reduced.

Additionally or alternatively in a torsional vibration damper, the first and/or second plurality of spring elements can comprise at least one spring element with a characteristic that is progressive in multiple steps, at least partially. In this way, it can be possible with comparatively simple technical manner to realize the corresponding characteristic of the stage of the torsional vibration damper. The characteristic of a spring element can represent a dependency of a force F or of a torque M as a function of a deformation of the spring element along the circumferential direction. In this respect, taking into account a radius r with respect to the common rotational axis of the torsional vibration damper with respect to the rotational movement, the torque M can be obtained as the product of radius r and the prevailing force F (M=F·r). Depending on the specific configuration, the deformation can be obtained, for example, through a twist angle, but also through a change in length along the circumferential direction. A spring element can comprise at least one spring but possibly also a plurality of springs as will be explained in the following.

In a torsional vibration damper, the at least one spring element can optionally have an outer spring and an inner spring, and the inner spring has a smaller outer diameter than an inner diameter of the outer spring and can be arranged at least partially along the circumferential direction inside the outer spring. In this way, it can be possible to create the preconditions for the implementation of an at least partially progressive multi-step characteristic with comparatively simple technical means. As the previous statements have also made clear, the inner spring can be both longer and shorter than the outer spring with reference to the circumferential direction. However, they can also extend along the circumferential direction over an identical range, i.e., for example, over an identical angular range.

In a torsional vibration damper, the outer spring or the inner spring can optionally be configured to contribute a torque component to the characteristic of the relevant step only after exceeding a step twist angle. In this way, the technical realization of the progressive multi-step characteristic or corresponding portion can be possible in a constructionally simple manner. Accordingly, the relevant inner spring or outer spring does not contribute its torque component to the characteristic of the relevant step until the twist angle exceeds the step twist angle. This can be implemented, for example, in that the relevant outer spring or inner spring is configured to be shorter than the other spring of the two springs, and the step twist angle represents the different length in the installed state of the outer spring and inner spring precisely with respect to angle. In this way, the relevant outer spring or inner spring will come in contact with the corresponding input component or output component only after the step twist angle has been exceeded and only then transmits the force to the relevant component and accordingly generates the above-mentioned torque component.

Additionally or alternatively in a torsional vibration damper, the at least one spring element can further have a middle spring which has an inner diameter which is greater than the outer diameter of the inner spring and an outer diameter which is smaller than the inner diameter of the outer spring. In this way, it can be possible to create the preconditions for a spring element with a 3-step characteristic with constructionally simple manner without investing in additional installation space.

Accordingly, in a torsional vibration damper of this type the middle spring can optionally be configured to contribute a torque component to the characteristic of the relevant stage of the torque converter only after a further step twist angle has been exceeded. The further step twist angle may differ from the previously mentioned step twist angle. Accordingly, in a torsional vibration damper of this type the step twist angle and the further step twist angle differ from one another by at least 20 Nm, for example. Accordingly, it can be possible, for example, to configure the first stage of the torsional vibration damper to be progressive over at least three steps in a constructionally simple manner and with efficient use of installation space.

Additionally or alternatively in a torsional vibration damper, the first characteristic and/or the second characteristic can at least have one continuously progressive portion comprising the at least one transition point. In this way, it can be possible to reduce or even completely prevent abruptly occurring changes in the vibration behavior or damping behavior of the torsional vibration damper and, accordingly, jerking back-coupling which can possibly be generated by the torsional vibration damper can be kept away from the system.

In this case also, the portion can also include the entire characteristic so that the latter always has a continuously progressive curve. The continuously progressive portion accordingly has a slope of the torque, as function of the twist angle in the relevant portion, which slope increases steadily with increasing static twist angle.

Additionally or alternatively in a torsional vibration damper, the first plurality of spring elements and/or the second plurality of spring elements can comprise at least one spring element with an at least partially continuously progressive characteristic. Accordingly, it may be possible with constructionally simple elements to realize a corresponding continuously progressive characteristic of the relevant stage of the torsional vibration damper associated with the relevant at least one spring element such that installation space is efficiently utilized.

In a torsional vibration damper, the at least one spring element can optionally comprise at least one first portion and a second portion, and a diameter of a wire of the spring in the first portion differs from a diameter of the wire of the spring in the second portion. Additionally or alternatively, a coil spacing of the wire of the spring in the first portion can also differ from a coil spacing of the wire of the spring in the second portion. Accordingly, the continuously progressive characteristic of a spring element of this type can be realized with comparatively simple technical elements. However, the spring element can also comprise a plurality of springs arranged in parallel, for example, so as to be nested one inside the other, as has already been described. In the event that the coil spacing of the wire of the spring in the first portion of the spring diverges from that in the second portion of the spring, the spring can go solid, for example, i.e., the individual turns of the wire of the spring can abut when the spring is correspondingly loaded. Regardless of this, each of the portions of the spring can comprise a turn or more than one turn but also possibly less than one turn. In the latter case, the respective magnitudes, i.e., for example, the diameter or the coil spacing, are determined by corresponding consideration of the limit value. For example, the coil spacing can be derived based on the slope or the angle under which the wire is coiled.

Additionally or alternatively in a torsional vibration damper, the first stage of the torsional vibration damper can be configured to deliver a first maximum torque. The second stage of the torsional vibration damper can be configured to deliver a second maximum torque, and the first maximum torque can differ from the second maximum torque. It can also be possible in this way, if applicable, to reduce an impact load even when the load limit of the torsional vibration damper has been reached.

Accordingly, in a torsional vibration damper of this type, the first maximum torque and the second maximum torque can optionally differ by a value between 10 Nm and 20 Nm. In this way, it can be possible to prevent the above-described compensation with respect to a jerky back-coupling when the stops are encountered on the one hand, but without unnecessarily heavy underutilization of the possible constructionally-determined twist angles.

In torsional vibration dampers of this type, the second maximum torque can optionally be higher than the first maximum torque. In this way, it can be possible, if applicable, to keep the first stage active, while the second stage of the torsional vibration damper is already in its stop. Components, which are accordingly coupled to the intermediate mass or output, can possibly profit from the residual damper capacity caused by the difference between the two maximum torques.

Additionally or alternatively in a torsional vibration damper of this type, a first maximum twist angle of the first stage of the torsional vibration damper associated with the first maximum torque can be greater than a second maximum twist angle of the second stage of the torsional vibration damper associated with the second maximum torque. In this way, it can be possible to configure the second stage of the torsional vibration damper to be softer overall, since torsional vibrations have been damped at least preliminarily through the first stage. Accordingly, it can be possible to improve the performance of a torsional vibration damper of this type and/or reliability overall and thus to affect the above-mentioned compromise in a positive manner.

Additionally or alternatively, a torsional vibration damper can further comprise a damper mass carrier structure configured to moveably guide the at least one damper mass such that the at least one damper mass can perform the oscillation. The damper mass carrier structure can either be connected to the output of the torsional vibration damper so as to be fixed with respect to rotation relative to it or can be part of the intermediate mass of the torsional vibration damper. In other words, the damper mass carrier structure can be connected to the output or to a component part between the two stages of the torsional vibration damper so as to be fixed with respect to relative rotation. In this way, it can be possible to protect the tuned mass vibration damper, with its at least one damper mass, from overloading through the first stage of the torsional vibration damper if not even through the first stage and the second stage of the torsional vibration damper. In this way, it can be possible to improve the above-mentioned compromise not least of all with respect to the functionality of the torsional vibration damper and reliability. Depending on the specific configuration, it may possibly be beneficial to construct the damper mass carrier structure as part of the intermediate mass and accordingly to allow the second stage of the torsional vibration damper to profit from the damping capability of the tuned mass vibration damper comprising the at least one damper mass. In this regard, the damper mass carrier structure can optionally be constructed as a separate component part or can also be implemented as part of another component.

A starting element which can be used, for example, for a powertrain of a motor vehicle comprises an input, an output and a torsional vibration damper in a configuration that has already been described. The torsional vibration damper is coupled with its input and its output between the input and the output of the starting element.

Optionally, the starting element can further comprise a frictionally engaging clutch configured to substantially interrupt or establish a torque flow via the frictionally engaging clutch. The torsional vibration damper can be coupled either between the input of the starting element and the frictionally engaging clutch, between the frictionally engaging clutch and the output of the starting element, or between the first stage and the second stage of the torsional vibration damper. For example, the frictionally engaging clutch can be formed as part of the intermediate mass. Accordingly, the intermediate mass can possibly be configured such that it comprises two parts which can be brought into communication with one another via the frictionally engaging contact.

A frictionally engaging contact or a frictionally engaging connection exists when two objects enter into frictionally engaging contact with one another such that a force is formed therebetween in case of a relative movement perpendicular to a contact surface between them, allowing a transmission of force, of a rotational movement or of a torque. In this regard, there can be a difference in rotational speed, i.e., slip, for example. But apart from this type of frictionally engaging contact, a frictionally engaging contact also includes a frictional or non-positive engagement connection between the relevant objects in which a corresponding difference in rotational speed, or slip, essentially does not occur.

Additionally or alternatively, a starting element can be a torque converter, wherein the starting element comprises a turbine wheel which is either connected to the output of the torsional vibration damper so as to be fixed with respect to rotation relative to it or is part of the intermediate mass of the torsional vibration damper.

A powertrain for a motor vehicle comprises an internal combustion engine, a transmission and a starting element coupled between the internal combustion engine and the transmission. The powertrain further comprises a torsional vibration damper such as has already been described. The torsional vibration damper is coupled between the internal combustion engine and an output of the transmission. Accordingly, in a powertrain of this type the torsional vibration damper can optionally also be part of the starting element so that the starting element is of the type already described.

Additionally or alternatively, the individual component parts can be integral and/or produced in one piece. In this way, it can be possible to facilitate the production and/or assembly of individual components. A component formed in one piece may be, for example, a component made from precisely one contiguous piece of material. A component or structure made, provided or produced in one part or a component or structure made, provided or produced integral with at least one further component or structure can be, for example, a component or structure that cannot be separated from the at least one further component without destroying or damaging one of the at least two components concerned. Accordingly, a one-piece structural component part or a one-piece component is also at least a structural component part or component which is formed integral with, or forms one part with, another structure of the relevant structural component part or component.

Additionally or alternatively, the torsional vibration damper and/or components thereof can be configured to be rotationally symmetrical, as a result of which, for example, functionality can be improved and/or production can be facilitated. For example, the cover plate and/or receiving component can be rotationally symmetrical. A component can have an n-fold rotational symmetry, for example, where n is a natural number greater than or equal to 2. An n-fold rotational symmetry exists, for example, when the relevant component can be rotated by (360°/n) around an axis of rotation or axis of symmetry and substantially transitions into itself with respect to shape, i.e., substantially self-maps in a mathematical sense after a certain rotation. In contrast, a completely rotationally symmetrical component substantially transitions into itself with respect to shape when rotated by any amount and by any angle around the axis of rotation or axis of symmetry, i.e., substantially self-maps in the mathematical sense. An n-fold rotational symmetry and a complete rotational symmetry are both referred to herein as rotational symmetry.

A mechanical coupling of two components includes a direct as well as an indirect coupling, i.e., for example, a coupling via a further structure, a further object or a further component. A non-positive or frictionally engaging connection is brought about through static friction, bonding is brought about through molecular or atomic interactions and forces, and a positive engagement connection is brought about through a geometric connection of the relevant parts to be connected. Therefore, static friction generally presupposes a normal force component between the two parts to be connected.

### BRIEF DESCRIPTION OF THE DRAWINGS

Various examples will be described and discussed in the following with reference to the accompanying drawings.

FIG. 1 is a schematic block diagram of a starting element;

FIG. 2 is a schematic block diagram of a powertrain;

FIG. 3 is a cross section through a starting element in the form of a torque converter;

FIG. 4A is a partial elevation as a top view of a torsional vibration damper of the starting element shown in FIG. 3;

FIG. 4B is an arrangement of the spring elements of the torsional vibration damper shown in FIG. 4A;

FIG. 5 is a first example of characteristics of a first stage and second stage of a torsional vibration damper;

FIG. 6 is a first example of characteristics of a first stage and second stage of a torsional vibration damper;

FIG. 7 is a first example of characteristics of a first stage and second stage of a torsional vibration damper;

FIG. 8A is a partial elevation in the form of a top view of a torsional vibration damper comparable to FIG. 4A;

FIG. 8B is a schematic view comparable to FIG. 4B of the arrangement of the spring elements of the torsional vibration damper from FIG. 8A;

FIG. 9 is a partial elevation in the form of a top view of a further torsional vibration damper;

FIG. 10 is a partial elevation in the form of a top view of a further torsional vibrations damper; and

FIG. 11 schematically shows a highly simplified top view of a further torsional vibration damper.

### DETAILED DESCRIPTION OF THE PRESENTLY PREFERRED EMBODIMENTS

Identical or comparable components are denoted by identical reference numerals in the following description of the accompanying drawings. Further, collective reference numerals are used for components and objects which occur more than once in an embodiment example or diagram but which are described collectively with respect to one or more features. Components or objects which are denoted by identical reference numerals or collective reference numerals may be constructed identically or possibly also differently with respect to one or more or all features, for example, their dimensions, unless otherwise explicit or implicit from the description.

In many areas of plant engineering, mechanical engineering and vehicle engineering, a challenge consists in removing, or at least damping, one or more torsional vibration components from a rotational movement. Corresponding torsional vibration components of a rotational movement can occur in prime movers operating on the principle of reciprocating pistons by reason of their construction and design. Examples include Otto engines and diesel engines in which an abrupt development of force takes place which can lead to the corresponding rotational irregularities and, therefore, corresponding torsional vibration components.

In order to keep corresponding torsional vibration components away from downstream components, or at least to reduce them, torsional vibration dampers can be used, for example, in which a transmission of torque takes place via one or more spring elements. The spring element or spring elements serve to temporarily absorb the surplus energy contained in the torsional vibration components, vis-à-vis a mean energy of the rotational movement, which can be given back to the rotational movement again in correct phase from the spring elements. Accordingly, a temporary excessive increase in energy or torque can be captured and coupled into the rotational movement again in correct phase through the use of one or more corresponding spring elements.

A large number of boundary conditions which differ in part must be taken into account when adapting or configuring a corresponding torsional vibration damper to the specific application. Apart from the actual damping of the torsional vibrations or rotational irregularities, an easy implementation and production of a torsional vibration damper of this type, the installation space required by it and the reliability of the torsional vibration damper and of the system that comprises the torsional vibration damper are not the least of the goals to be met. For example, torsional vibration dampers are used in the realm of torque converters with speed-adaptive vibration absorbers in combination with a two-damper converter, i.e., a two-tiered or two-stage torsional vibration damper arrangement. In this way, a decoupling of vibrations in which, for example, the rotational irregularities brought about by the internal combustion engine can at least be reduced, can be achieved. In systems of this kind, the speed-adaptive vibration absorber, also known as tuned mass vibration damper, is frequently arranged either on the intermediate mass between the relevant spring sets or on the secondary side, i.e., downstream of the second spring set, at the output of the torsional vibration damper.

Not least of all for ecological reasons, a goal and effort of the vehicle manufacturer is to reduce carbon dioxide (CO₂) emissions while at the same time reducing expenditure as much as possible, for example, so as to lower costs. These goals are realized with respect to the engine by reducing the cubic capacity and lowering the speed of the rate of rotation of the internal combustion engines and other components of the powertrain. These steps are also referred to as downsizing or downspeeding.

However, this can lead to an increase in the rotational irregularities and torsional vibrations in a powertrain of this kind. Therefore, in order to maintain comfort and to maintain operating reliability it may be advisable to implement systems for decoupling rotational irregularities, i.e., torsional vibration dampers, for example, which enable improved damping of torsional vibrations. In this respect, in spite of the technical steps mentioned above, the trend is to realize a reduction in residual rotational irregularities and accordingly to counteract losses in comfort and/or in service life.

The use of a torsional vibration damper such as that described in the following can accordingly enhance the decoupling quality of a torque converter, for example, or of another starting element, for example, in the lower speed range which is regarded as particularly critical, so that a potential for reducing the starting speed may possibly also be realized in this case.

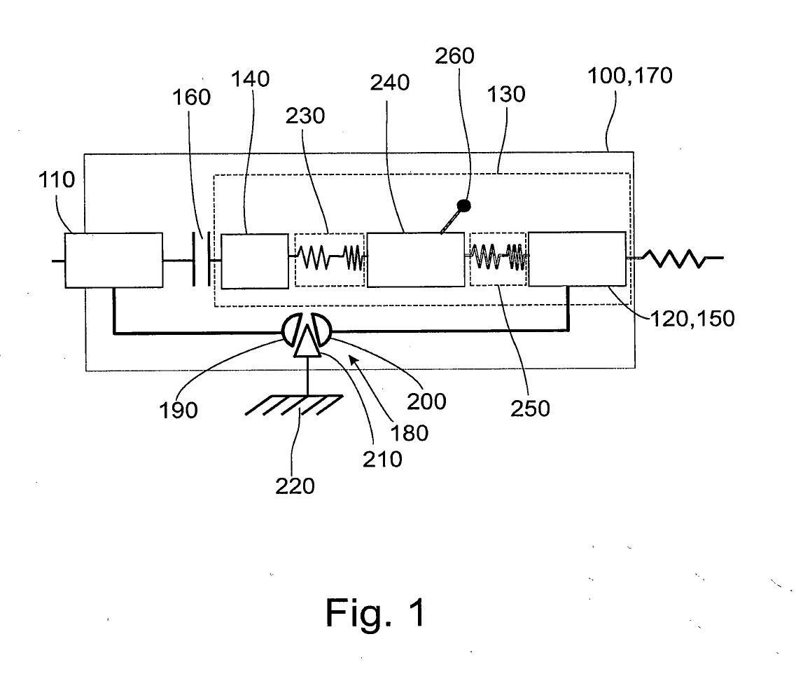

FIG. 1 shows a schematic block diagram of a starting element 100 comprising an input 110 and an output 120. The starting element 100 further comprises a torsional vibration damper 130 which in turn has an input 140 and an output 150 which, with regard to the starting element 100 shown here, also concerns output 120 of the starting element 100. Input 140 of the torsional vibration damper 130 is configured as a second portion of a primary mass of the starting element 100, while input 110 of the starting element constitutes a further part of the primary mass, also referred to in FIG. 1 as “part 1” of the primary mass. The starting element 100 further comprises a frictionally engaging clutch 160 which is coupled between input 110 of the starting element 100 and input 140 of the torsional vibration damper 130. Depending on the specific configuration, the clutch 160 substantially serves to interrupt a torque flow via the clutch 160 or to establish a corresponding torque flow. In case of a frictionally engaging clutch 160 closed in the unloaded condition (normally closed), for example, the torque flow across the clutch 160 can be interrupted by controlling the clutch in a corresponding manner. However, in the event that the clutch 160 is one that is typically open in its initial condition so that, in this condition, it is impossible for torque to be transmitted past the clutch 160 (normally open), the flow of torque past the clutch 160 can be effected by controlling the clutch 160 in a corresponding manner. A clutch 160 of this kind can be constructed, for example, based on frictionally engaging contact between corresponding friction surfaces.

The starting element 100 shown in FIG. 1 is, more precisely, a torque converter 170 which, in addition to the clutch 160, allows a second torque transmission path via a pump-turbine arrangement 180. The pump-turbine arrangement 180 comprises an impeller 190 coupled to the input 110 of the starting element so as to be fixed with respect to relative rotation and during operation generates a hydrodynamic flow which can interact with a turbine 200 of the pump-turbine arrangement 180. In this way, a torque can be transmitted from the impeller 190 to the turbine 200; in the present example of a starting element 100 the turbine 200 is coupled with output 120 or output 150 of the starting element 100 and of the torsional vibration damper 130 so as to be fixed with respect to relative rotation.

The pump-turbine arrangement 180 further comprises a stator 210 coupled via a freewheel, not shown in FIG. 1, to a support 220, for example, in the form of output 120 of the starting element 100 and/or in the form of output 150 of the torsional vibration damper 130. Stator 210 can accordingly be utilized to excessively increase torque and can be supported at the support 220 via the above-mentioned freewheel.

Since the starting element 100 is a torque converter 170, the clutch 160 is also referred to as a lockup clutch for the pump-turbine arrangement 180.

The torsional vibration damper 130 has a first plurality of spring elements 230, also denoted as C1 in FIG. 1, arranged between input 140 and an intermediate mass 240 of the torsional vibration damper and coupled therewith. The first plurality of spring elements 230, also denoted as first spring set or outer spring set, forms a first stage of the torsional vibration damper 130. Correspondingly, the torsional vibration damper 130 has a second plurality of spring elements 250 arranged between the intermediate mass 240 and the output 150 of the torsional vibration damper 130, also referred to secondary mass. The spring elements of the second plurality 250 are correspondingly coupled between the intermediate mass 240 and output 150 of torsional vibration damper 130 and accordingly form a second stage of a torsional vibration damper 130.

The first plurality of spring elements 230 and the second plurality of spring elements 250 are shown schematically as two springs arranged one after the other in order to show that the first stage of the torsional vibration damper 130 and the second stage of the torsional vibration damper 130 both have a progressive characteristic with at least one transition point. Although, additionally or alternatively, parallel arrangements of springs can often be used instead of a series arrangement in actual implementation, corresponding progressive characteristics can certainly also be realized by serial arrangements of springs. The first stage of the torsional vibration damper 130, i.e., the first plurality of spring elements 230, is also denoted in FIG. 1 by C1, and the second stage or second plurality of spring elements 250 is designated in FIG. 1 by C2. “C” denotes the stiffness of the respective stage of the torsional vibration damper 130, i.e., a slope or change or deflection in the characteristic as function of the twist angle φ. For example, the characteristics represent the torque M provided by the respective stage during a static twisting around a determined twist angle φ, where the twist angle refers to an unloaded equilibrium state or basic state of the torsional vibration damper 130 in which a vanishing torque (0 Nm) is provided by the respective stage of the torsional vibration damper. Thus in a mathematical sense, the stiffness C is the derivative of the characteristic according to the twist angle (C=dM/dφ).

The torsional vibration damper 130 further has at least one damper mass 260 coupled with the intermediate mass 240 in the starting element shown here and is referred to as a DAT (speed-adaptive damper). In other examples of a starting element 100 or of a torsional vibration damper 130, the at least one damper mass 260 can also be coupled, for example, with output 150, i.e., the secondary mass, of the torsional vibration damper 130. As will be shown later, the at least one damper mass 260 can be moveably guided through a damper mass carrier structure such that the at least one damper mass 260 is able to perform a corresponding oscillation depending on the rotational movement in order to damp a vibration component of the rotational movement. Depending on the specific configuration, the damper mass carrier structure can be part of the intermediate mass 240, for example, but can also be connected to output 150 so as to be fixed with respect to rotation relative to it and accordingly form part of the secondary mass. The damper mass carrier structure can be constructed as a separate component part, but also as part of another component.

The input 110 of the starting element 100 can be coupled, for example, to an internal combustion engine, while the output 150 can be connected, for example, to a transmission input shaft of a transmission, not shown in FIG. 1, such that output 150 is fixed with respect to rotation relative to the transmission input shaft. In this way, it can be possible to allow the internal combustion engine to continue to run even in a stationary condition of the motor vehicle during which the transmission input shaft is typically also stationary. In such a case, the torque flow via the clutch 160 can be interrupted by opening the clutch 160 correspondingly, whereas it is also possible for the transmission input shaft to be stationary during a rotation of the input 110 of the starting element 100 owing to the absence of the rigid or rotationally locked connection between the impeller 190 and the turbine 200.

The first characteristic of the first stage of the torsional vibration damper 130 has at least one transition point because of its progressive shape. Correspondingly, the second characteristic of the second stage of the torsional vibration damper 130 also has at least one corresponding transition point because of its progressive shape. The transition points of the first characteristic and of the second characteristic are spaced apart from one another with respect to the torque. Depending on the specific configuration, the torsional vibration damper 130 can be constructed such that, for example, the transition points have a distance from one another of at least 20 Nm with respect to the torque. Adjacent transition points of the first characteristic and of the second characteristic can have a distance of at most 100 Nm from one another and between different characteristic lines, for example. As a result of a corresponding configuration, it can now be possible to realize a total characteristic of both stages of the torsional vibration damper in cooperation with the tuned mass vibration damper and the at least one damper mass 260 so that the decoupling quality for rotational irregularities or torsional vibrations can be improved to the extent that starting is possible even at low speeds.

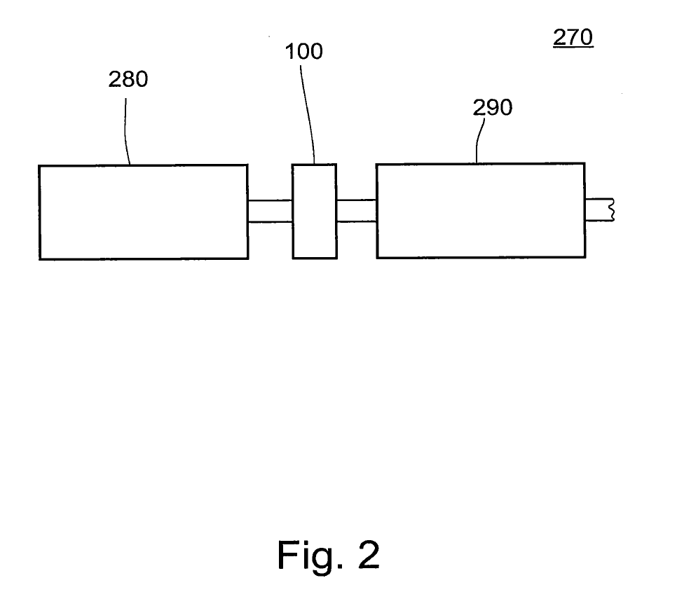

FIG. 1 shows a dynamic diagram of a corresponding vibration absorber damper system which can be connected, for example, between an internal combustion engine and a transmission. To illustrate this more fully, FIG. 2 shows a schematic block diagram of a powertrain 270 comprising an internal combustion engine 280 and a transmission 290. A starting element 100, for example, can be coupled between the internal combustion engine and the transmission 290 as has been described referring to FIG. 1, for example. This starting element 100 can comprise a torsional vibration damper 130 coupled between the internal combustion engine 280 and an output of the transmission 290. Also, in other examples a conventional starting element 100 can also be integrated instead of a starting element 100 having a torsional vibration damper 130 of the type described above, for example, when the torsional vibration damper 130 is constructed as part of the transmission 290. The transmission 290 can be implemented, for example, as a shift transmission with a plurality of fixed speed gear ratios, but may also be implemented as a continuously variable transmission or a combination of these. In case of a shift transmission or a corresponding partial transmission, it can be implemented, for example, on the basis of planetary gear sets, but also on the basis of a spur gear unit.

The internal combustion engine can be a reciprocating piston engine, for example, i.e., an Otto engine or a diesel engine. However, other internal combustion engines may also be used. Likewise, the internal combustion engine 280 can comprise additional components of an electric motor, for example, in order to form a hybrid drive unit. A corresponding hybrid module can be constructed, for example, as part of the internal combustion engine 280, starting element 100 or transmission 290 in its entirety or partially.

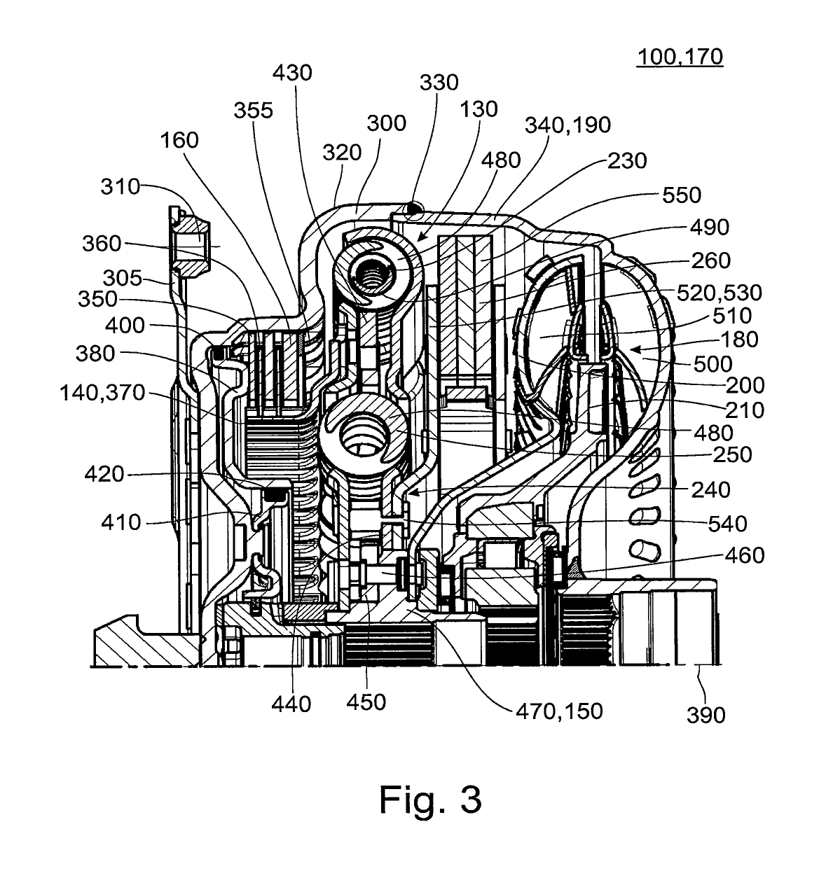

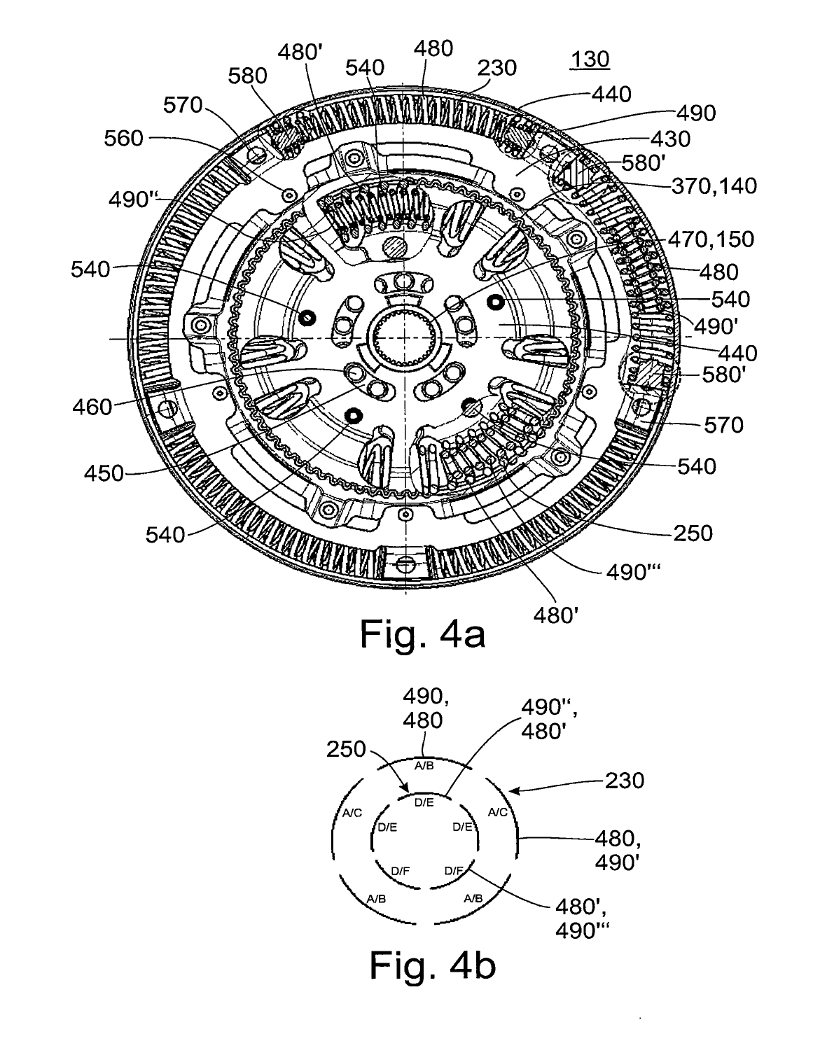

While FIG. 1 shows a dynamic diagram of the torque converter 170 with speed-adaptive vibration absorber on the intermediate mass 240, a more precise constructional configuration of a corresponding starting element 100 will now be described referring to FIGS. 3, 4A and 4B. The multi-stepped configuration of the characteristic of the torsional vibration damper 130, also referred to as torsion damper characteristic, is realized in that the first plurality of spring elements 230 and second plurality of spring elements 250 are configured in two steps with different bending torques, i.e., different transition points. In order to increase the torque which can be transmitted with the corresponding spring elements with tolerable tensions in the spring elements, outer springs and inner springs are used in this case, and the inner springs have a smaller diameter so that they can be inserted into the outer springs. Together, these springs form a spring element, also designated spring package. However, a spring element may also comprise only one individual spring. On the other hand, it is also possible to insert a third, even smaller spring into the inner spring so that the latter becomes a middle spring arranged between an outer spring and an inner spring.

The two-step configuration can be produced in this case by using shorter inner springs, since the latter only make contact at the aimed-for or intended limit torque, also referred to as bending torque, and are accordingly not active until the spring element continues to twist and the spring stiffness of the stage in question is increased via this parallel arrangement of individual springs. FIG. 3 shows a cross section through a corresponding starting element, while FIG. 4A shows a top view of a corresponding torsional vibration damper and FIG. 4B schematically shows an arrangement of the spring elements.

FIG. 3 shows a cross section through a starting element 100 in the form of a torque converter 170 in order to illustrate more fully the basic construction of a torque converter 170 of this type having a speed-adaptive vibration absorber on the secondary side. The starting element 100 has a housing 300 connected to a flexible plate 305 so as to be fixed with respect to rotation relative to it for mechanically coupling the starting element 100 to the internal combustion engine 280, not shown in FIG. 3. The flexible plate 305 is also referred to as flexplate and in the configuration shown here has, for example, a plurality of bore holes 310 distributed along a circumferential direction for mechanical connection.

The housing 300 has, more precisely, a first housing shell 320, also referred to as cover, connected via welding 330 to a second housing shell 340. As a result of the welding 330, the two housing shells 320, 340 form a fluidically sealed volume inside of which the torsional vibration damper 130 is arranged. The clutch 160, also referred to as converter lockup clutch, is likewise arranged in the inner volume. This clutch 160 has a plurality of outer disks 350 which engage with the first housing shell 320 via a corresponding toothing structure in order to transmit a rotational movement from the first housing shell 320 of housing 300 to the outer disks 350. Accordingly, housing 300 or the first housing shell 320 thereof forms an outer disk carrier 355 with which the outer disks 350 engage. The clutch 160 further has inner disks 360 which are arranged between the outer disks and which can have friction linings, for example, in order to form a frictionally engaging contact with the outer disks 350. The inner disks 360 engage with an inner disk carrier 370 likewise via a corresponding toothing.

A piston 380 is displaceable along an axis 390 so as to displace the inner disks 360 and the outer disks 350 along axis 390 and accordingly bring them into frictional engagement. The piston 380 is sealed relative to the rest of the interior of the housing 300 via a seal 400. The piston space which is accordingly formed between the first housing shell 320 and piston 380 can be supplied with pressure via a corresponding inlet bore so as to produce or cancel the frictional engagement in a specific configuration of the clutch 160. The clutch 160 further has a spring element 410 riveted to the first housing shell 320 and sealed via a further seal 420.

In the embodiment of the torsional vibration damper 130 shown here, the inner disk carrier 370 is connected to a central disk 430 so that the torque coupled in via the inner disk carrier 370 or the rotational movement coupled in via the inner disk carrier 370 is coupled into the torsional vibration damper 130. The inner disk carrier 370 can accordingly be viewed as input 140 of the torsional vibration damper 130. The central disk 430 now makes contact with the first plurality of spring elements 230. The corresponding spring elements form the stiffness of the first stage of the torsional vibration damper 130. The spring element of the first plurality of spring elements 230 makes contact with two cover plates 440 via which the rotational movement is transmitted from the first plurality of the spring elements 230 to the second stage of the torsional vibration damper 130. The cover plates 440 are connected to one another so as to be fixed with respect to relative rotation and are formed not only so as to serve as actuating plates or deactivating plates for the spring elements of the first plurality of spring elements 230, but also form a spring channel for them at which the spring elements of the first plurality of spring elements can make contact radially outside and radially inside when required.

Beyond this, the cover plates 440 also serve as control components for the spring elements of the second plurality of spring elements 250 arranged farther radially inside. These spring element of the second plurality of spring elements 250 forms the second stage of the torsional vibration damper 130 and contacts a hub disk 450 to receive the rotational movement transmitted via the second plurality of spring elements 250. The spring element of the second plurality of spring elements 250 accordingly forms the second stage of the torsional vibration damper 130, also designated as second stiffness C2.

The hub disk 450 is connected via riveting 460 to an output hub 470, also designated as torsion damper hub, so as to be fixed with respect to rotation relative to it. The output hub 470 has an internal toothing via which the transmission input shaft, not shown in FIG. 3, and a correspondingly shaped outer toothing thereof can introduce the rotational movement into the transmission, also not shown in FIG. 3.

As will be described more fully referring to FIGS. 4A and 4B, the spring elements of the first plurality of spring elements 230 and the spring elements of the second plurality of spring elements 250 are configured such that they have an outer spring 480 and an inner spring 490 in each instance. However, the spring elements are not necessarily identically configured inside the first plurality of spring elements 230 and inside the second plurality of spring elements 250 as will be described in more detail referring to FIGS. 4A and 4B. The section plane shown in FIG. 3 intersects the inner spring 490 and the outer spring 480 in the area of the first plurality of spring elements 230, while the position of the section plane in the area of the second plurality of spring elements 250 in which the operating situation on which FIG. 3 is based intersects only the outer spring 490. As will be described in the following referring to FIGS. 4A and 4B, the spring elements of the pluralities of spring elements 230, 250 can comprise inner springs which are shorter than the outer springs, for example. However, spring elements in which the inner spring 490 and outer spring 490 have substantially the same length can also be implemented.

As was already mentioned referring to FIG. 1, the starting element 100 has a pump-turbine arrangement 180 owing to its configuration as torque converter 170. The second housing shell 340 also serves as impeller 190 which is also designated simply as pump. Connected to this impeller 190 is a plurality of impeller vanes 500 which cause a flow of fluid in direction of the turbine or turbine wheel 200 because of the rotational movement of the housing 300. Accordingly, the turbine 200 also has a plurality of turbine blades 510 distributed along the circumferential direction and which transform the fluid flow caused by the impeller 190 into a rotational movement. Here again, the circuit of the fluid flow actuated through the impeller 190 is closed via a stator 210.

To couple the torque transmitted via the pump-turbine arrangement 180 to the output hub 470 which can form the output 150 of the torsional vibration damper, for example, the turbine 200 is likewise connected via the riveting 460 to the output hub 470 so as to be fixed with respect to rotation. In other embodiments, however, the turbine 200 can also be connected with a part of the intermediate mass 240 of the torsional vibration damper 130.

In the example shown here, the intermediate mass 240 comprises, for example, the track plates 440 of the torsional vibration damper 130 and the track plates 530 acting as damper mass carrier structure 420 are likewise connected via riveting 540 to cover plates 440 and, therefore, intermediate mass 240 so as to be fixed with respect to relative rotation. Track plates 530 serve to moveably guide the damper masses 260, which are moveably guided at the damper mass carrier structure 520 via rolling elements, for example, so that the damper masses 260 can perform an oscillation for damping a vibration component of the rotational movement. In the present example of a corresponding speed-adaptive vibration absorber, damper masses 260 are formed of multiple parts and, in this case, include in each instance a plurality of, in the present instance, three, individual damper masses 550 along axis 390.

In the present example of a torsional vibration damper 130, the damper masses 260, also designated as flyweights, are guided through two track plates, which are spaced apart from one another along axis 390 and collectively form the damper mass carrier structure 520. In other embodiments, it can also be possible to guide the damper mass 260 at both sides of an individual track plate 530 or at both sides of an individual damper mass carrier structure 520. In the example shown here, the torsional vibration damper 130 further comprises a plurality of damper masses 260. In other embodiments, the number of damper masses can also possibly be increased or reduced. Accordingly, it can also be possible, if necessary, to use only one individual damper mass 260 instead of the plurality of damper masses 260 arranged here along the circumferential direction.

As has already been indicated briefly, the intermediate mass 240 also comprises the damper mass carrier structure 520 in the form of track plates 530, since it is connected via riveting 540 to the cover plates 440 so as to be fixed in respect to rotation relative to it. Riveting 540 also provides for a spacing of the individual track plates 440 along the axis.

In other configurations, the damper mass carrier 520, i.e., for example, track plates 530, can also be connected directly to the output hub 470, i.e., the output 150 of the torsional vibration damper 130. The turbine 200 can also be connected to the intermediate mass so as to be fixed with respect to rotation relative to it by riveting 540 instead of riveting 460. In this case, the second stage of the torsional vibration damper 130 and possibly also the speed-adaptive vibration absorber with its at least one damper mass 260 could be utilized, depending on its connection, for damping rotational irregularities or torsional vibrations transmitted via the pump-turbine arrangement 180.

FIG. 4A shows a top view of the torsional vibration damper 130 from FIG. 3 in which the damper masses 260 are concealed by the cover plates 440 because of the viewing direction. More precisely, the view in FIG. 4A is a partial elevation showing, for example, the spring arrangements with their loose inner springs.

The partial elevation in FIG. 4A also shows the torque flow inside the torsional vibration damper 130 from its input 140, i.e., the inner disk carrier 370, to its output 450 in the form of the output hub 470. Proceeding from input 140, i.e., the inner disk carrier 370, the rotational movement is transmitted to the central disk 430 initially via riveting 560. This central disk 430 has a plurality of control portions 570 which are arranged along the circumferential direction and which in turn contact a spring shoe 580 in each instance in the example of a torsional vibration damper shown here. The spring shoes 580 contact outer springs 480 of the spring elements of the first stage of the torsional vibration damper 130, i.e., the first plurality of spring elements 230. Further, the spring elements of the first plurality of spring elements 230 also have inner springs 490. In this case, inner springs 490, 490′ of different lengths are used. As is shown at the top in FIG. 4A, the inner spring 490 has, for example, substantially the same length along the circumference as the corresponding outer spring 480. Correspondingly, the spring shoes 580 are also formed in such a way that they always contact both the outer spring 480 and the inner spring 490. The spring shoes 580 have a radial clearance with respect to the inner springs 490 and also with respect to the outer springs 480.

In contrast, while the outer springs 480, shown, for example, at the upper right-hand side of FIG. 4A, are identical to the outer springs 480 used above, inner springs 490′ differ in length from inner springs 490 above. Correspondingly, the latter also come into contact with the corresponding spring shoes 580′ only at a later point in time, namely, only after exceeding a step twist angle. In contrast to spring shoes 580, spring shoes 580′ have different surfaces in the present example which are oriented substantially perpendicular to the circumferential direction in order to make contact with the relevant springs 480, 490′. However, the spring shoes 580′ also have a radial clearance with respect to the outer springs 480 and the inner springs 490′ in this instance.

The torque is transmitted from the first plurality of spring elements 230 via the cover plates 440 to the second plurality of spring elements 250. The torque transmitted via the second plurality of spring elements 250 and the corresponding riveting 460 is then transmitted via the hub disk 450 to the output hub 470, i.e., the output 150 of the torsional vibration damper 130.

In this case too, however, different spring elements are used in the area of the second plurality of spring elements 250. While the outer springs 480′ are also identical in this case for all of the spring elements of the second plurality of spring elements 250, two inner springs 490″ and 490′ of different lengths are used. The above-mentioned inner springs 490″ have the same length as the corresponding outer springs 480′. In contrast, the shorter inner springs 490″′ which are shown on the lower right-hand side, for example, have a smaller extension along the circumferential direction than the corresponding outer springs 480′ of the second plurality of spring elements 250, for example. Accordingly, through corresponding use of both short and long inner springs 490 in the area of the spring elements of the first plurality of spring elements 230 and second plurality of spring elements 250, a progressive characteristic of the relevant stages of the torsional vibration damper 130 can be implemented, wherein the corresponding transition points, which are knees of the respective characteristics at corresponding twist angles in this case, are spaced apart from one another.

FIG. 4B once again summarizes this arrangement of the inner springs 480 and outer springs 490 of the respective pluralities 230, 250 of spring elements. In this regard, uppercase characters A and D denote, respectively, the outer springs 480 and 480′ of the first plurality of spring elements 230 and of the second plurality of spring elements 250. The alphabetic character B denotes the long inner springs 490 of the first plurality of spring elements 230, while alphabetic character C denotes the short inner springs 490′ of the outer first plurality of spring elements 230. Correspondingly, alphabetic character E represents the long inner springs 490″ of the second plurality of spring elements 250, while alphabetic character F represents the short inner springs 490″′ of the second plurality of spring elements. Accordingly, in the torsional vibration damper 130 shown in FIGS. 3, 4A and 4B the spring elements of the first plurality of spring elements are arranged according to the sequence A/B-A/C-A/B-A/B-A/C. Accordingly, in the example of the torsional vibration damper 130 shown here the first plurality of spring elements includes five spring elements arranged equidistantly along the circumferential direction. The second plurality of spring elements 250 also comprises five equidistantly arranged spring elements which, however, differ slightly with respect to their arrangement from the arrangement just described. Accordingly, they are arranged according to the sequence D/E-D/E-D/F-D/F-D/E. In this case, the spring elements of the first plurality of spring elements 230 and spring elements of the second plurality of spring elements 250 are arranged precisely such that a corresponding spring element of the second plurality of spring elements 250 is arranged along a radially outwardly extending line wherever there is a spring element of the first plurality of spring elements 230, and vice versa. In other words, the two pluralities of spring elements 230, 250 in the torsional vibration damper 130 shown here are not arranged so as to be offset relative to one another. In this regard, at least in the example shown here, the spring elements of the two pluralities of spring elements 230, 250 are also arranged precisely so that the former spring elements are arranged along a common radial direction and the latter spring elements of the two pluralities of spring elements 230, 250 are arranged correspondingly, etc.

The pluralities of spring elements 230, 250 accordingly form an outer spring set and an inner spring set, wherein the spring elements of the corresponding spring sets are configured in each instance as spring packages with an outer spring and an inner spring. In other examples, however, the arrangements can also be different. For example, instead of a spring package, an individual spring can form a spring element, or more than two springs can form a corresponding spring package or spring element.

With regard to the mode of functioning of the torsional vibration damper 130 and especially with regard to the speed-adaptive vibration absorber, this is a Sarazin-type absorber. An absorber of this type can be used by itself as torsional vibration decoupling system only with difficulty within the framework of a starting element 100, particularly within the framework of a torque converter 170, since the torsional vibrations introduced into the system through the engine are often too severe for a vibration absorber. On the other hand, if a vibration absorber were configured in such a way that it had a sufficiently high decoupling capacity, it could probably not be utilized in a feasible manner economically or ecologically so that a preliminary decoupling in the form of an upstream decoupling system using spring sets, for example, is always advisable. For example, in case of greater engine torques of 500 Nm or more, for example, a high alternating torque of 1100 Nm or more, for example, can also occur on the order of one half of the quantity of cylinders. With the given installation spaces in current passenger motor vehicles, for example, it is scarcely possible at such high alternating torques to sufficiently decouple the resulting rotational irregularities with only one individual spring set, i.e., an individual plurality of spring elements and one vibration absorber. Therefore, it is advisable to use two pluralities of spring elements (spring sets) in addition to a vibration absorber precisely in torsional vibrations dampers 130 for more powerful internal combustion engines.

By reason of its basic physical configuration the vibration absorber applies increasing torque with increasing speed. This can also provide a further reason for using a preliminary decoupling system, for example, because this ultimately means that the vibration absorber applies fewer mass damper torques for lower speeds at which there is a greater likelihood based on the system that rotational irregularities will occur. In this speed range, it may be advisable to configure the preliminary decoupling system, i.e., the pluralities of spring elements or the corresponding torsion damper, such that it performs most of the decoupling of rotational irregularities.

A good decoupling can be carried out, for example, when the system is operated as far as possible from the natural frequency in this supercritical range. This means either that the dimensions should be as large as possible, although this should be valuated rather as critical for ecological and economic reasons, or that the stiffness should be as low as possible. A further restriction as concerns design parameters consists in that only a limited swiveling angle or oscillating angle φ is available because typically only 360 are available for transmitting torque via a corresponding component part (e.g., plate), for further transmitting torque via the spring elements and guiding torque out via another corresponding component part (e.g. plate) for twisting. This means that with a lower spring rate of the spring set, i.e., for example, with values of about C=12 Nm/degrees, the torsional vibration damper 130 reaches its mechanical end stop at a predetermined percentage of the nominal torque (M=φ·C). This is also known as partial load configuration.

An alternative consists in using a two-step or multi-step characteristic of the spring set, which is progressive. The use of two two-step or multi-step spring sets, including the mounting of the vibration absorber between these spring sets, constitutes a configuration of a torsional vibration damper 130.

As described in the present case, a two-step configuration of this kind can be realized by short inner springs 490. In this way, rotational irregularities which occur can also be decoupled comparatively well in a lower torque range and, therefore, based on the engine characteristic, also in the lower speed range. The full engine torque can nevertheless be transmitted via the spring elements without the hard mechanical stop being reached, which can lead every time to an impact load and, therefore, to an impact excitation in the overall system.

There are essentially four parameters in a two-step spring characteristic. This includes the stop torque, the stop angle, the bending torque and the bending angle. The stop torque cannot be selected arbitrarily because the entire engine torque should be transmitted with predetermined reliability when a torsional vibration damper of this type is reliably constructed and configured. The stop angle is frequently design-based, which leaves only the bending torque and the bending angle as free parameters. Therefore, the first section or the first sub-portion of a characteristic of this type can be configured to be softer than the corresponding spring rate without the two-step configuration. In the second section or second sub-portion of the respective characteristic, the behavior can be exactly the opposite. The bending torque with two-step configuration can be configured in such a way that upwards of the speed of the full-load characteristic of the engine associated with this torque, for example, at speeds ranging between 1100 and 1500 revolutions per minute, for example, in the range between 1100 and 1400 revolutions per minute, the vibration absorber can feed back a sufficiently high mass damper torque so that the residual rotational irregularity is sufficiently small.

The bending torque is calculated from the sum of the product of the stiffness rates (C rates) of the first stage and the swiveling angle of the primary mass or of the input 140 of the torsional vibration damper 130 at a determined speed n1 and the torque at speed n1 from the engine curve.

There remains the matter of the bending angle. This determines the stiffness or softness of the spring stages. Thus, in principle, it could be considered that the first stage should be as soft as possible in order to ensure optimal decoupling. However, it has been shown that the stiffness of the second stage should not exceed the stiffness of the first stage beyond a factor c_{1.2}/c_{1.1} in a range between 1.6 and 7.

Thus the bending torque is a torque that is typically in the middle of the typical driving range so that this is often driven through. If the above-mentioned factor c_{1.2}/c_{1.1} is too high, there can be a shock-like excitation of the powertrain every time this point is driven through so that other vibration orders can even be excited. Owing to the high stiffness of the second stage that then exists, this means, in addition, that there is still a small residual angle for this spring set. Accordingly, because of the high alternating torque of the engine, which was described above, the torsional vibration damper can then possibly vibrate in its mechanical end stop. Upwards of a certain amplitude, these effects can have negative consequences for the decoupling behavior and, therefore, for the residual rotational irregularities of the system overall.

This also applies to the second spring set, i.e., the second stage of the torsional vibration damper 130 and, accordingly, to the second plurality of spring elements 250. It should also be taken into account in this connection that the knees or transition points are configured to the same torque—and a torsional vibration damper 130 not least of all is based on this. These knees or transition points should be spaced apart from one another and should have, for example, a difference of ΔMₖₙₑₑ=20-100 Nm. Otherwise, it may happen that the jump between steps in the overall torsional vibration damper system is again too large. The difference of bending torques accordingly provides for a smoother transition.

It may also be advisable with regard to the stop torque e of the spring sets, i.e., the stages of the torsional vibration damper 130 and the corresponding pluralities of spring elements 230, 250, not to configure the latter exactly to the same torques. Accordingly, it may be advisable, for example, to configure the second plurality of spring elements 250, i.e., the second stage of the torsional vibration damper 130, to be lower than the stop torque of the first stage of the torsional vibration damper 130 (the first plurality of spring elements 230). A difference with respect to the torques ΔMₛₜₒₚ can be in the range between 10 and 20 Nm, for example.

A further possibility for generating a smoother transition in the area of the knees is to configure at least one stage of the torsional vibration damper to have three or even more steps. For example, both stages of the torsional vibration damper can be configured in three steps, although it could possibly be beneficial to configure the first stage of the torsional vibration damper 130 in particular in three steps in a corresponding manner. This can be realized, for example, through a further shorter inner spring which can be used in place of the long inner springs 490 or C shown, for example, in FIGS. 4A and 4B. However, the measures mentioned above should also be adhered to again in this case. Accordingly, it may possibly be advisable to also implement a difference with respect to the torque of ΔMₖₙₑₑ of 20 to 100 Nm between the second stage and third stage, for example. In this way, it can also be possible to make a smoother transition into the next step. Otherwise, it can also happen in this case that the jumps between steps in the overall system are too large.

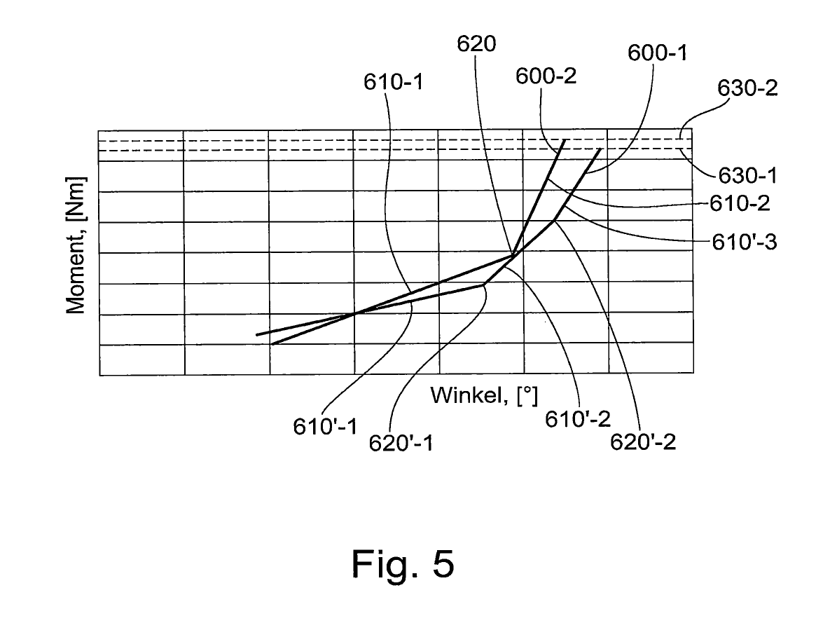

Referring to FIGS. 5, 6 and 7, three different possibilities for configuring the various torsional vibration dampers 130 will be described in the following. These three examples merely illustrate basic variants which can in turn be correspondingly adapted in other torsional vibration dampers 130.

Accordingly, FIG. 5 shows two characteristics 600-1, 600-2, where characteristic 600-1 is configured progressively in three steps, while characteristic 600-2 is progressive in two steps. Characteristic 600-2 has a first sub-portion 610-1 followed immediately by a second sub-portion 610-2 at a transition point 620. Within the two sub-portions 610, characteristic 600-2 has a constant slope that changes abruptly at transition point 620. Accordingly, a derivation of characteristic 600-2 is constant in each instance in the first sub-portion 610-1 and in the second sub-portion 610-2 although the derivation takes on different values. At transition point 620, however, the derivation has a discontinuity in the mathematical sense during which the slope abruptly changes.

This also applies in principle to characteristic 600-1. The latter also has a plurality of sub-portions 610′-1, 610′-2 and 610′-3 immediately adjoining one another, and the sub-portions 610′ in question extend up to transition points 620′-1 and 620′-2, respectively. Accordingly, in this case the first characteristic 600-1 and the second characteristic 600-2 have a total of three transition points 620, wherein transition point 620 of characteristic 600-2, i.e., the corresponding knee of this stage of the torsional vibration damper 130, lie between the transition points 620′ of the other stage of the torsional vibration damper 130. Here also, the transition points 620 are spaced apart from one another along the torque axis, wherein the distances can be, for example, at least 20 Nm and the distances between two adjacent transition points, regardless of the characteristics 600 to which they belong, can have a maximum spacing of 100 Nm, for example. However, both boundary conditions only represent examples which can be implemented completely independent from one another. Beyond this, FIG. 5 shows that a maximum torque 630 can differ between the two stages of the torsional vibration damper 130. This maximum torque 630 can differ, for example, by values between 10 Nm and 20 Nm.

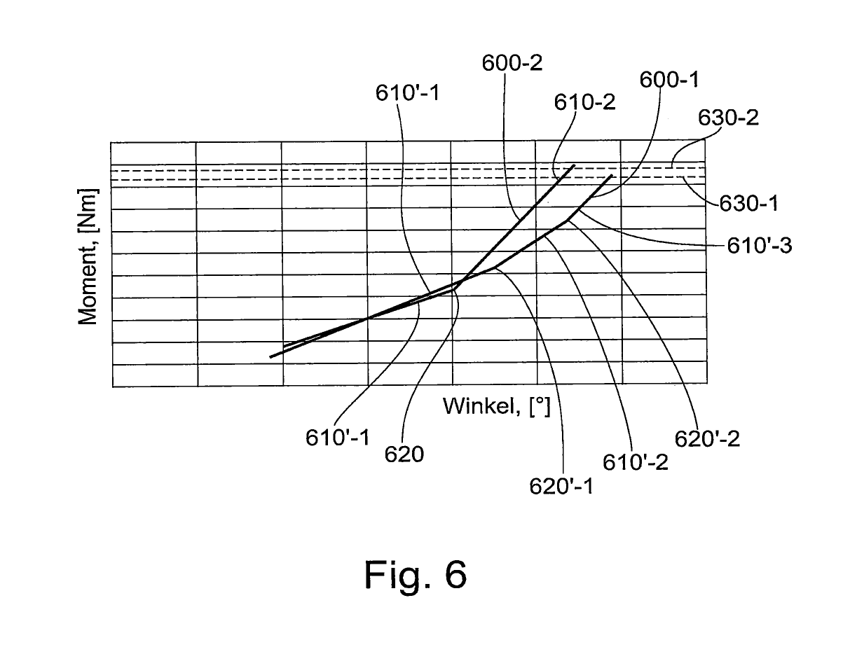

FIG. 6 shows another diagram with two characteristics 600-1, 600-2 which differs from the diagram shown in FIG. 5 substantially in that the transition point 620 of characteristic 600-2 now lies at lower values and below the corresponding transition points 620′-1, 620′-2 of characteristic 600-1 with respect to torque and twist angle. Accordingly, the knee of characteristic 600-2 lies below the two knees 620′-1, 620′-2 of characteristic 600-1.

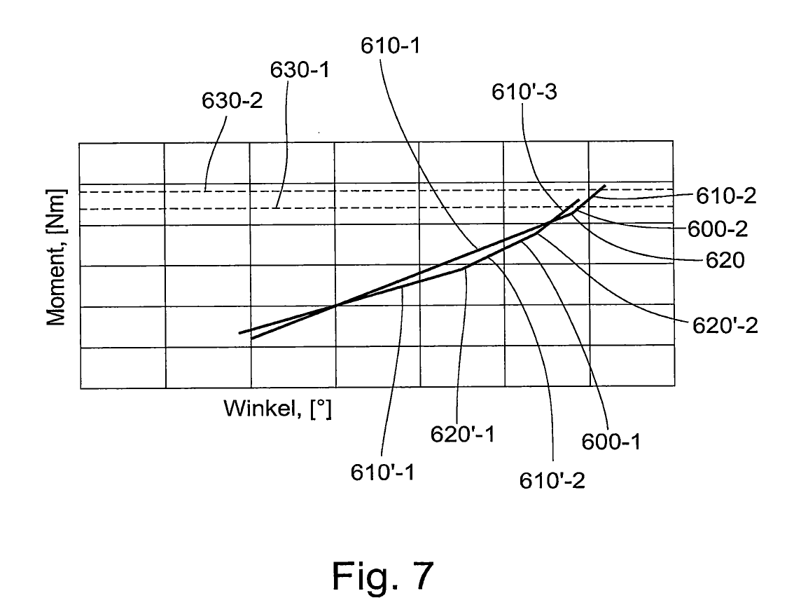

FIG. 7 shows a further diagram that resembles the diagrams from FIGS. 5 and 6 and also shows two characteristics 600-1, 600-2. Here again, characteristic 600-1 is configured in three steps, while characteristic 600-2 is configured in two steps. The situation depicted in FIG. 7 differs from the previous situations substantially in that the transition point 620 now lies above transition points 620′-1, 620′-2 of characteristic 600-1 with respect to both torque and twist angle. In other words, knee 620 of characteristic 600-2 lies above the two knees 620′-1, 620′-2 of characteristic 600-1.

A further possibility for generating the corresponding configuration of the characteristics 600, i.e., for example, their two-step configuration, consists in using progressively coiled springs. These may differ along the length of the respective spring, for example, with respect to a diameter of the wire used for the springs, but springs with varying coil spacing can also be used. For example, there can also be two possibilities again for a continuous progressivity and a progressivity by segments. In case of a continuous progressivity, for example, the stiffness can increase continuously. This can eliminate any jump between steps and, therefore, the overall system does not “oscillate against a step.” In the case of a progressivity configured by segment, individual portions of the relevant springs or spring elements can be configured progressively. This can result in a curve similar to that in a two-step or multi-step characteristic with short inner springs. However, it can happen that the relevant characteristics are rounded in the area of the transition points. This can be because the second segment of the spring is co-loaded resulting in a series connection of the two segments of the spring.

Depending on the type of transmission or internal combustion engine for which a torsional vibration damper 130 is provided, the threshold quotient of the stiffnesses of the respective spring sets, for example, can deviate from the values described above. Depending on the specific embodiment, the configuration can be determined in this case by simulations or trials, for example.

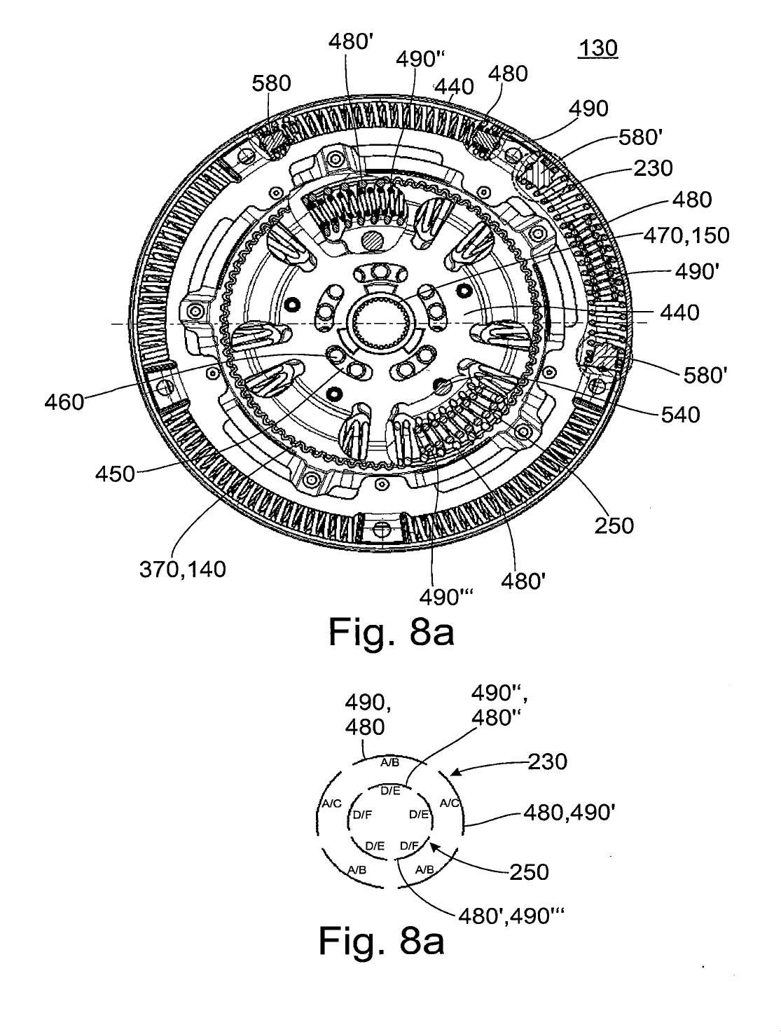

The characteristics, which are shown by way of example in FIGS. 5, 6 and 7, can be determined, for example, by simple torque measurements after exposing the relevant torsional vibration damper and coupling the torque into the relevant component parts. While characteristics may not be immediately discernable visually, they can be determined by simple methods for defining a torsion damper characteristic and possibly by measuring the rotational irregularities in the vehicle or on a corresponding test stand. The structural features, i.e., for example, the two-step configuration of the torsional vibration damper and the implementation of the at least one damper mass 260, can also be visually determined without difficulty. FIGS. 8A and 8B again show a partial elevation of a further torsional vibration damper 130 and a corresponding schematic diagram of the first plurality of spring elements 230 and second plurality of spring elements 250. Accordingly, FIGS. 8A and 8B also show a torsional vibration damper with more than one stage and with a two-step first plurality and second plurality of spring elements 230, 250 in this case also.

FIG. 8A again shows a decoupling system in which the torsional vibration damper is shown with a two-step first plurality of spring elements 230 and a two-step second plurality of spring elements 250. In this configuration, the transition points 620 or knees of the respective stage of the torsional vibration damper are again deliberately not consecutive as has already been described referring to 5 to 7. Here also, corresponding torsional vibration dampers can also be implemented in which at least one of the stages of the torsional vibration damper 130 is configured in multiple steps as only two steps.

Here also, outer springs 480 (A in FIG. 8B) of identical length are again implemented within the framework of the first plurality of spring elements. However, inner springs 490 of different lengths are again implemented. At the top of FIG. 8A, for example, long inner springs 490 (B in FIG. 8B) are used, whereas short inner springs 490′ are used on the upper right-hand side, for example. In this case again, the spring shoes 580, 580′ are correspondingly implemented as has already been described referring to FIG. 4A. In particular, spring shoes 580, 580A also have a radial clearance with respect to inner springs 480 and outer springs 490.

As regards the second plurality of spring elements, i.e. the inner spring set, the corresponding spring elements again have outer springs 480′ (D in FIG. 8B) of identical lengths in this case. Likewise, long inner springs 490″ (E in FIG. 8B) are again used, for example, at the top of FIG. 8A, while short inner springs 490″′ (F in FIG. 8B) are used on the lower right-hand side of FIG. 8A.

Accordingly, the spring elements of the first plurality of spring elements 230 are configured as A/B-A/C-A/B-A/B-A/C. Correspondingly, the spring element of the second plurality of spring elements 250 has the configuration D/E-D/E-D/F-D/E-D/F. Here also, the spring elements of the two pluralities 230, 250 of spring elements are again arranged so as to be aligned without an offset, and the first, second, third, fourth and fifth spring elements are arranged in each instance as indicated above on a radial line proceeding from the axis 390, not shown in FIG. 8A.

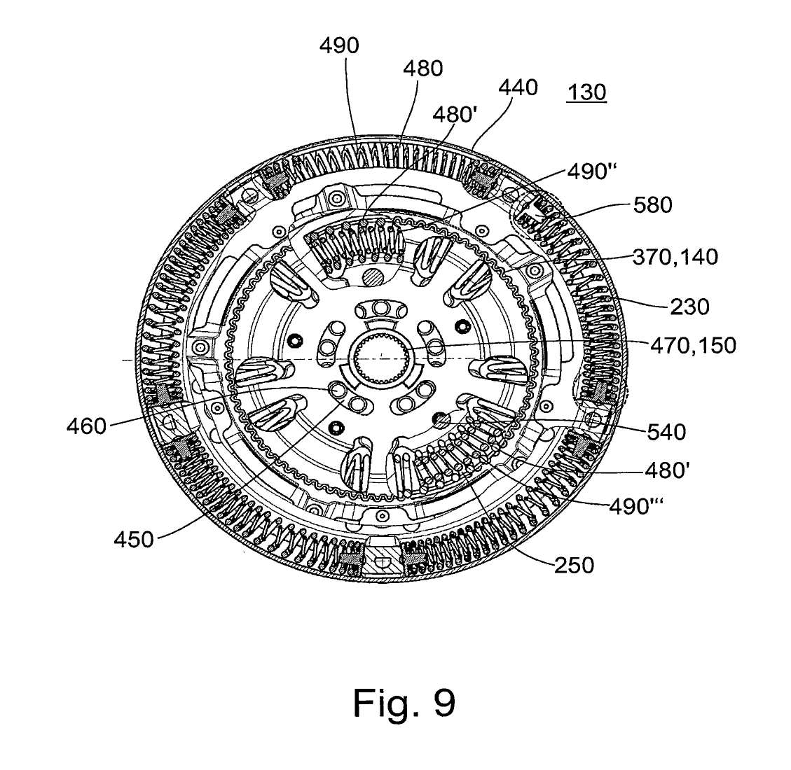

FIG. 9 shows another embodiment of a torsional vibration damper 130 as a partial elevation such as was already shown, for example, in FIGS. 4A and 8A. The embodiment shown in FIG. 9 differs from the embodiment shown in FIG. 8A substantially with respect to the use of progressive springs within the framework of the spring elements of the first plurality of spring elements 230. Accordingly, FIG. 9 shows a torsional vibrations damper with progressive springs within the framework of the spring elements of the first plurality of spring elements 230 arranged radially outside and form the first stage of torsional vibration damper 130. In this respect, within the framework of the first plurality of the spring elements 230, identical inner springs 490 and outer springs 480, both of which are configured differently with respect to the coil spacing in the respective springs 480, 490, are used in each instance for all of the spring elements. Accordingly, individual portions of the outer springs 480 and inner springs 490 of the first plurality of spring elements 230 can touch one another and therefore go solid during corresponding twisting. A corresponding bridging of individual portions of the relevant springs 480, 490 can accordingly take place so that the previously described progressivity of the corresponding characteristic of the spring element is realized. Because of the identical configuration of the inner springs 490 and outer springs 480 of the first plurality of spring elements, identical spring shoes 580 which again have clearance with respect to the two springs 480, 490 along the radial direction are also used here.

As regards the spring elements of the second plurality of spring elements 250, the configuration does not differ from the configuration which was described referring to FIG. 8A and 8B.

FIG. 9 shows a torsional vibration damper 130 in which a continuous progressive curve is achieved through the use of progressive springs. Although only the spring elements of the outer spring set, i.e., of the first plurality of spring elements 230, are configured correspondingly in this example, the springs of the spring elements of the second plurality of spring elements 250 can also be implemented in a corresponding manner.

Accordingly, a torsional vibration damper can be implemented, for example, with progressive inner springs or exclusively progressive inner springs 490 in the area of the outer spring set, i.e., of the first plurality of spring elements 230. In a further embodiment, not shown, the progressivity can also be brought about, for example, via only one spring type of a corresponding spring set or of a corresponding plurality of spring elements 230, 250. For example, only the respective outer spring or only the inner spring may be configured so as to be continuously progressive. In this respect, it may possibly be advisable to select a variant in which the inner springs are progressive and the outer springs are linear. This can allow the outer springs to transmit a larger torque and thus become the main springs of the corresponding stage of the torsional vibration damper. In contrast, the correspondingly progressively configured inner springs can be utilized merely to transmit the progressive curve. However, the outer springs can also be configured so as to be progressive in a corresponding manner, while the inner springs are linear. For example, it can be possible to dimension and configure the outer springs in such a way that, although they have a progressive characteristic, they nevertheless transmit a majority of the forces or torques.

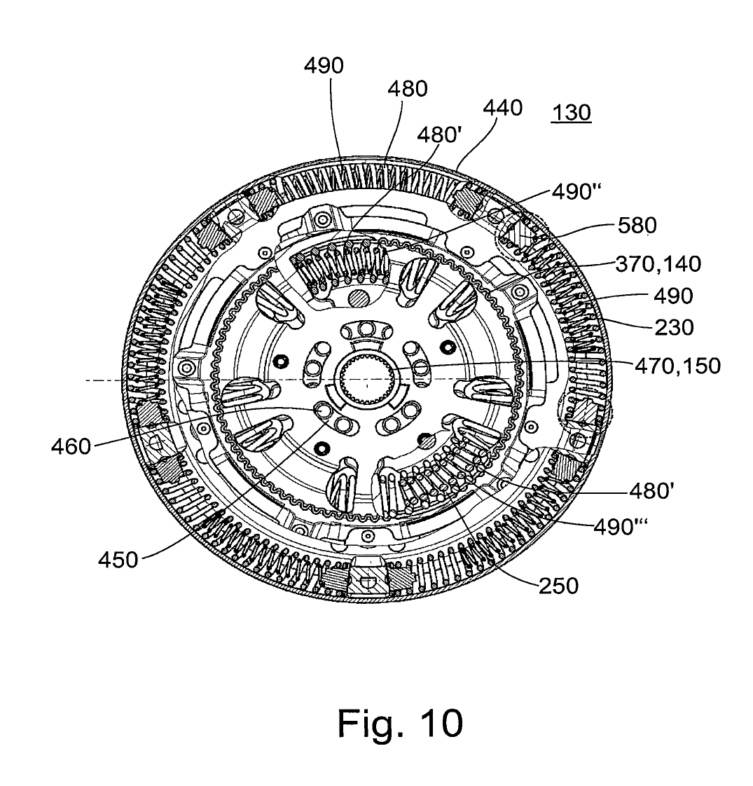

FIG. 10 shows a partial sectional view, as has already been shown in FIGS. 4A, 8A and 9, of a further torsional vibration damper 130 in which the second stage of the torsional vibration damper, i.e., the second plurality of spring elements 250, is configured in accordance with the version in FIG. 9 or FIGS. 8A and 8B. But here also, the spring elements of the first plurality of spring elements 230 are again identically constructed, although the latter are configured with identical lengths this time, namely every time, but the outer springs 480 are long springs, while the inner springs 490 are shorter springs. Correspondingly, the spring shoes 580 are again also configured in this case in such a way that they are designed for the shorter inner springs 490, and there is also a radial clearance between the spring shoes 580 and the corresponding outer and inner springs 480, 490 again in this case. The embodiment shown in FIG. 10, however, differs from the previously described torsional vibration dampers in that the springs are configured in the present instance so as to be only partially progressive. One or more springs are configured so as to be progressive to the first 1 to 3 degrees so as to round off a jump between steps. These progressive turns lie against the next turn, i.e., go solid, with increasing torque after the above-mentioned 1 to 3 degrees. They are accordingly shut off and only the residual, linear portion of the relevant spring is then still in frictional engagement. Accordingly, FIG. 10 shows a torsional vibration damper with short inner springs 490 configured to be partially progressive.

However, other implementations can also be provided in which, for example, the multi-stepped configuration of the first plurality of spring elements 230 is realized through progressively coiled springs. Accordingly, bending torques can possibly no longer be spoken of but rather transition points as has already been described. As a result of the corresponding coil spacings, the tightly coiled spring turns can contact one another with increasing torque so that the turn-for-turn effect is shut off and a virtually constant progressivity can accordingly be achievable. The transition points accordingly change to a broad transition range or bending torque range. For example, progressively coiled springs 480 can be used as spring elements instead of spring packages within the framework of the spring elements of the outer spring set, i.e., of the first plurality of spring elements or of the first stage of the torsional vibration damper.

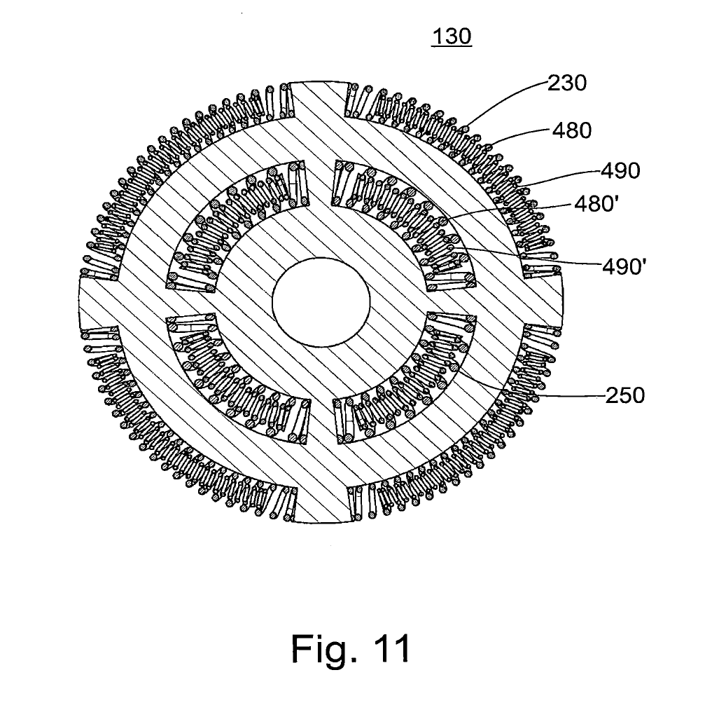

FIG. 11 schematically shows a highly simplified depiction of a further torsional vibration damper 130 in which the fivefold configuration of the torsional vibration damper as described previously is replaced by a fourfold configuration. Accordingly, in contrast to the previous depictions, FIG. 11 shows only a simplified model without showing the components of the speed-adaptive absorber, the application, stops or other components. However, this does not mean that no speed-adaptive absorbers or damper masses 260 are implemented. Besides the implementation of a fourfold parallel connection in place of the previously shown fivefold parallel connection of the relevant spring elements which are again pre-bent, springs with a maximum length are used in each instance for the first plurality of spring elements 230 and for the second plurality of spring elements 250 as outer springs 480, 480′, while the inner springs 490, 490′ for both pluralities of spring elements 230, 250 are short springs.

Here also, a progressive configuration of the characteristics of the two stages of the torsional vibration damper 130 can again be achieved correspondingly through a corresponding configuration of springs 480, 490, wherein the transition points are again spaced apart from one another.

Springs 480, 490 of the spring elements are constructed in this case as curved springs but can also be realized as straight springs in other implementations. The spring ends can also be utilized as shown in FIG. 11, for example.

Precisely when using mechanical springs, the use of four or five parallel-connected spring elements in each plurality of spring elements 230, 250 can benefit a compromise with respect to friction, possible twist angles and other parameters. A parallel connection of fewer spring elements can allow a larger twist angle in principle, but can lead to an increase in friction. Correspondingly, an increase in the quantity of parallel-connected spring elements can lead to a decrease in the available twist angle range but can have a favorable effect on wear and friction. Therefore, it can certainly be possible to realize torsional vibration dampers also with more or fewer spring elements than the four or five parallel-connected spring elements shown herein. Also, it is far from compulsory that the first stage and second stage of the torsional vibration damper 130 have the same quantity of parallel-connected spring elements.

While torque converters have substantially been described in the present case by a vibration absorber and a torsion damper with two or more steps in both spring sets, torsional vibrations dampers can also be used within the framework of other starting elements, for example, wet or dry clutches. Corresponding torsional vibration dampers can also be used in other locations, for example, in a hybrid module or as part of the transmission of a corresponding powertrain.

The features disclosed in the preceding description, the subsequent claims and the accompanying figures may be of importance and be implemented, both individually and in any combination, for the realization of an embodiment example in their various implementations.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-15. (canceled)

16. A torsional vibration damper configured to damp a vibration component of a rotational movement, comprising:
an input;
an output;
an intermediate mass arranged between the input and the output;
a first plurality of spring elements coupled between the input and the intermediate mass that forms a first stage of the torsional vibration damper, the first stage of the torsional vibration damper has a progressive first characteristic with at least one transition point;
a second plurality of spring elements coupled between the intermediate mass and the output that forms a second stage of the torsional vibration damper, the second stage of the torsional vibration damper has a progressive, second characteristic with at least one transition point; and
at least one damper mass configured to perform an oscillation depending on the rotational movement to damp the vibration component of the rotational movement,
wherein all of the transition points of the first characteristic of the first stage of the torsional vibration damper and the second characteristic of the second stage of the torsional vibration damper are spaced apart from one another with respect to torque.

17. The torsional vibration damper according to claim 16, wherein the transition points of the first characteristic and of the second characteristic have a distance from one another of at least 20 Nm with respect to torque.

18. The torsional vibration damper according to claim 16, wherein adjacent transition points of the first characteristic and of the second characteristic with respect to torque have a spacing of at most 100 Nm with respect to torque.

19. The torsional vibration damper according to claim 16, wherein at least one of the first characteristic and the second characteristic have at least one portion that is progressive in multiple steps and comprises the at least one transition point.

20. The torsional vibration damper according to claim 19, wherein the at least one of the first characteristic and the second characteristic have at least one portion with a characteristic that is progressive in at least three steps.

21. The torsional vibration damper according to claim 16, wherein at least one of the first plurality of spring elements and the second plurality of spring elements comprise at least one spring element with a characteristic that is at least partially progressive in multiple steps.

22. The torsional vibration damper according to claim 21,
wherein the at least one spring element has an outer spring and an inner spring, and
wherein the inner spring has a smaller outer diameter than an inner diameter of the outer spring and is arranged at least partially along a circumferential direction inside the outer spring.

23. The torsional vibration damper according to claim 22, wherein one of the outer spring and the inner spring is configured to contribute a torque component to the characteristic of a respective step only after exceeding a step twist angle.

24. The torsional vibration damper according to claim 16, wherein at least one of the first characteristic and the second characteristic have at least one continuously progressive portion comprising the at least one transition point.

25. The torsional vibration damper according to claim 16, wherein at least one of the first plurality of spring elements and the second plurality of spring elements comprise at least one spring element with an at least partially continuously progressive characteristic.

26. The torsional vibration damper according to claim 16,
wherein the first stage of the torsional vibration damper is configured to deliver a first maximum torque,
wherein the second stage of the torsional vibration damper is configured to deliver a second maximum torque, and
wherein the first maximum torque can differ from the second maximum torque.

27. The torsional vibration damper according to claim 26, wherein the first maximum torque and the second maximum torque differ by a value between 10 Nm and 20 Nm.

28. The torsional vibration damper according to claim 16, further comprising:
a damper mass carrier structure configured to moveably guide the at least one damper mass such that the at least one damper mass can perform the oscillation,
wherein the damper mass carrier structure is one of connected to the output of the torsional vibration damper so as to be fixed with respect to rotation relative to it and is part of the intermediate mass of the torsional vibration damper.

29. A starting element for a powertrain of a motor vehicle, comprising:
an first input;
an first output; and
a torsional vibration damper having an input and an output configured to damp a vibration component of a rotational movement, the torsional vibration damper coupled by the input and the output between the first input and the first output of the starting element, the torsional vibration damper, comprising:
the input;
the output;
an intermediate mass arranged between the input and the output;
a first plurality of spring elements coupled between the input and the intermediate mass that forms a first stage of the torsional vibration damper, the first stage of the torsional vibration damper has a progressive first characteristic with at least one transition point;
a second plurality of spring elements coupled between the intermediate mass and the output that forms a second stage of the torsional vibration damper, the second stage of the torsional vibration damper has a progressive, second characteristic with at least one transition point; and
at least one damper mass configured to perform an oscillation depending on the rotational movement to damp the vibration component of the rotational movement,
wherein all of the transition points of the first characteristic of the first stage of the torsional vibration damper and the second characteristic of the second stage of the torsional vibration damper are spaced apart from one another with respect to torque.

30. The starting element according to claim 29, configured as a torque converter,
wherein the starting element further comprises:
a turbine connected to one of the output of the torsional vibration damper so as to be fixed with respect to rotation relative to it and is part of the intermediate mass of the torsional vibration damper.
